(19) United States
(12) Patent Application Publication
(10) Pub. No.: US 2007/0067132 A1
(43) Pub. Date: Mar. 22, 2007

(54) METHOD AND APPARATUS FOR ROUTING DATA STREAMS AMONG INTELLIGENT ELECTRONIC DEVICES

(76) Inventors: Demetrios A. Tziouvaras, Vacaville, CA (US); Kenneth J. Fodero, Pullman, WA (US); David E. Whitehead, Pullman, WA (US); Tony J. Lee, Pullman, WA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/533,083

(22) Filed: Sep. 19, 2006

Related U.S. Application Data
(60) Provisional application No. 60/718,365, filed on Sep. 19, 2005.

(51) Int. Cl. G01M 19/00; H02H 9/02

(52) U.S. Cl. 702/122; 307/125; 361/93.1

(57) ABSTRACT

Provided is an intelligent electronic device for protection, monitoring, controlling, metering or automation of lines in an electrical power system is provided. The intelligent electronic device is adapted to communicate with a variety of other intelligent electronic devices. In one embodiment, the intelligent electronic device includes a communication configuration setting configured to allow communication with one of the other intelligent electronic devices. An input element is further provided in communication with the communication configuration setting, whereupon a signal from the input element selects a particular communication configuration setting therein, thereby allowing for communication with one of the other intelligent electronic devices.

### CROSS-REFERENCE TO RELATED APPLICATIONS

This application claims benefit under 35 U.S.C. § 119(e) of U.S. Provisional Application entitled “Method and Apparatus for Routing Data Streams Among Intelligent Electronic Devices”, filed on Sep. 19, 2005, having Ser. No. 60/718,365, naming Demetrios Tziouvaras, Kenneth J. Fodero, Tony J. Lee, and David E. Whitehead as inventors, the complete disclosure thereof being incorporated by reference.

### BACKGROUND OF THE INVENTION

The present invention generally relates to electric power systems including intelligent electronic devices (IEDs) for protecting, monitoring, controlling, metering and/or automating electric power systems and associated transmission lines. More specifically, the present invention relates to a method and apparatus for routing data streams among IEDs associated with an electrical power system.

Electric utility systems or power systems are designed to generate, transmit and distribute electrical energy to loads. In order to accomplish this, power systems generally include a variety of power system elements such as electrical generators, electrical motors, power transformers, power transmission lines, buses and capacitors, to name a few. As a result, power systems must also include IEDs and procedures to protect the power system elements from abnormal conditions such as electrical short circuits, overloads, frequency excursions, voltage fluctuations, and the like.

Generally, IEDs are also used for protecting, monitoring, controlling, metering and/or automating electric power systems and associated transmission lines. For example, certain IEDs and procedures may act to isolate some power system element(s) from the remainder of the power system upon detection of the abnormal condition or a fault in, or related to, the power system element(s). Logically grouped zones of protection, or protection zones utilizing the IEDs and procedures, are established to efficiently manage faults or other abnormal conditions occurring in the power system elements. IEDs may include protective devices such as protective relays or otherwise, remote terminal units (RTUs), power line communication devices, bay controllers, supervisory control and data acquisition (SCADA) systems, general computer systems, meters, and any other comparable devices used for protecting, monitoring, controlling, metering and/or automating electric power systems and their associated transmission lines.

When protecting, monitoring, controlling, metering and/or automating electric power systems and associated transmission lines, it is often beneficial to reroute data streams such as communication signals therein in order to perform maintenance on protective devices or on power system elements associated thereto. For example, a power system element may require maintenance wherein the power system element and its associated protective device must be isolated from its associated transmission line. In order to maintain power distribution through the transmission line, power may be rerouted around the element that requires maintenance. In order to maintain protection, control, monitoring etc. of the transmission line, data streams such as communication signals must also be rerouted.

U.S. Pat. No. 6,510,154 for “Security System for network Address Translation Systems” describes a system for translating local IP addresses to globally unique IP address to allow hosts in an enterprise to share global IP addresses from a limited pool of such addresses available to the enterprise. The translation involves replacing the source or destination addresses in the headers of packets destined to or originating from the Internet. The system further detects whether the packets are DNS, ICMP, or FTP packets. Based on this detection, the packet is either allowed or disallowed to enter the network.

U.S. Pat. No. 6,438,585 for “System and method for Redirecting Message Attachments Between a Host System and a Mobile Data Communication Device” describes a system and method for forwarding information from a host system to a mobile data communication device upon sensing a triggering event. One potential triggering event includes sensing that a device is no longer in the vicinity of the host system. When a secondary user-defined event trigger occurs, the system may subsequently stop the redirection.

U.S. Pat. No. 6,154,839 for “Translating Packet Addresses Based Upon a User Identifier,” describes a system that allows data packets with requisite level of privilege to pass through a firewall. If the communication data packet has the required privilege level, the system replaces the source address in the data packet with a privileged address, and then forwards the data packet to the destination node.

U.S. Patent Publication No. US 2004/0136356 for a “Router and Method for Transmitting Packets” describes a router that, before routing, checks a NAT table to determine whether the table contains the address where a routing path to the destination address is stored. If the table contains the address, the router transmits the packet based on the routing information of the table. Otherwise, the router selects a routing path to the destination address from a routing table and transmits the packet based on the selected routing path.

U.S. Patent Publication No. US 2004/0071080 for a “Label Switching Router and Path Switchover Control Method Thereof” describes a label switching router and path switchover method that forwards messages when a path fault occurs. First, an active path is chosen from a table of a plurality of paths through which packets of an equivalent class are forwarded and for which priorities are set. Second, the information is routed over the selected path until the system detects a recovery of a path higher in priority than the active path, at which time the active path is switched back to a path higher in priority.

Nevertheless, the above patents and patent publications do not describe nor teach the rerouting of data streams in order to maintain protection, monitoring, controlling, metering and/or automating of a power transmission line. U.S. Pat. No. 6,639,330 for a “Transfer Relay for Computer Base Equipment” describes a power switching transfer relay to automatically switch an electrical load, such as that drawn by a computer or other sensitive electrical or electronic equipment, from a primary power source to a secondary, or backup, power source upon interruption or loss of the primary source. The transfer relay includes a power relay and two control relays that are arranged to switch the electrical power input from the primary source to the backup source upon failure of the primary power source in the space of less than one cycle, and to actuate an alarm upon loss of the primary power source, loss of the backup power source, or the occurrence of a relay fault.

U.S. Pat. No. 5,347,417 for a “Power Supply Protection System Applied to Optical Subscriber Network” describes a system for protecting a remote power supply for supplying power to an optical subscriber network, via a pair of power supply lines, from a remote power supply apparatus, with the power supply branch apparatuses inserted into the power supply lines in correspondence with each power receiving circuit respectively mounted in subscriber transmission nodes. Each of the power supply branch apparatuses comprises relay contacts inserted into its own power supply branch lines connected between the power supply lines and its own power receiving circuit, and a relay energized by an overcurrent detector or first and second communication units to change over the relay contacts. The relay contacts are opened and closed subscriber by subscriber sequentially to detect a faulty portion, and thereafter, the power is fed again selectively to the subscribers which have not experienced the fault.

U.S. Pat. No. 5,132,867, for a “Method and Apparatus for Transfer Bus Protection of Plural Feeder Lines” describes a microprocessor based tie relay for controlling a tie circuit breaker between a main bus and a transfer bus to which any one of a number of feeder lines may be connected through a disconnect switch when the feeder circuit breaker associated with that feeder line is out of service. Settings for the protection characteristics of each of the feeder relays controlling the feeder circuit breakers are stored in non-volatile memory together with a default protection characteristic suitable for protecting any of the feeder lines. The appropriate protection characteristic for the feeder line connected to the transfer bus is selected for use by the tie relay in controlling the tie circuit breaker. This selection may be made manually by an operator, or preferably automatically by the microprocessor of the tie relay which monitors the states of the feeder circuit breakers and of the disconnect switches and selects the settings associated with the feeder line whose feeder circuit breaker is open and disconnect switch is closed. If the microprocessor does not recognize only one feeder line connected to the transfer bus, the default protection characteristic is selected and an alarm is generated.

U.S. Pat. No. 5,041,737 for a “Programmable Bus-Tie Relay having a Plurality of Selectable setting Groups” describes a bus-tie relay apparatus which includes a multi-position mechanical switch and a logic circuit responsive to the position of the mechanical switch for producing digital signals on five digital lines, wherein a valid digital signal comprises the presence of high conditions on two, and two only, of said digital lines. A sensor senses the condition of the digital lines and retrieves the values of a relay element setting group from memory associated with that digital signal. A plurality of such relay element setting groups are stored in the apparatus, each one of which comprises values corresponding to the characteristics of an in-place relay associated with a particular one transmission line in a group thereof.

FIG. 1 generally provides an illustration of these traditional systems for applying IEDs, such as protective devices, in order to maintain protection, monitoring, controlling, metering and/or automating of an associated transmission line. It should be clear that while FIG. 1 and other figures show two transmission lines emanating from a single substation, the methods and systems described herein may be generally extended to more or less than two lines. In the described systems, local protective relays 20, 24 are associated with respective circuit breakers 22, 26 in a substation 28 for primary protection. For primary protection, upon detection of a fault condition on transmission lines 30, 32, the local protective relay 20, 24 associated with that particular transmission line 30, 32 signals a corresponding circuit breaker 22, 26 to isolate the fault. In this Figure, local protective relays 20, 24 are referred to as local relays and are further adapted to communicate with remote relays (not shown) via communications link 34, 36. The communications link may be, for example, fiber optic, a digital multiplexer, direct fiber optic, radio, and the like.

Circuit breakers are high maintenance devices which experience some wear each time they interrupt a fault condition. Accordingly, a substation is typically constructed such that each primary circuit breaker 22, 26 may be taken out of service for maintenance purposes or replacement while leaving its associated transmission line 30, 32 associated therewith energized. In these instances, it is necessary to isolate the primary circuit breaker 22, 26 along with its associated local protective relay 20, 24 in order to provide for secondary protection on the energized transmission line 30, 32. The local protective relay 20, 24 associated with the primary circuit breaker 22, 26 is commonly referred to as the primary relay.

A method for isolating a primary circuit breaker such as 22 or 26 while providing secondary protection in such instances is commonly referred to as a breaker bypass operation. As shown in FIG. 1, one traditional arrangement for providing secondary protection in such instances includes having a transfer bus 38 associated with a main or primary bus 40. In this arrangement, to isolate or take primary circuit breaker 26 out of service, all other lines are connected to the main bus 40 by proper configuration of switches 44, 46.

For example all other transmission lines are connected to the main bus 40 by closing the bottom part of associated switch 44 and opening the top part of associated switch 44. The top part of switch 46 closes such that line 32 is now connected to transfer bus 38 through switch 46. Because all other transmission lines have been transferred to main bus 40, line 32 is the only line connected to transfer bus 38. Therefore, all of the power that flows across line 32 also flows through circuit breaker 48. Bypass switch 50 is then closed which bypasses circuit breaker 26, and the disconnect switches 52a,b associated with breaker 26 are opened.

Circuit breaker 48 and its associated relay 54 now provide protection for the transmission line 32. This circuit breaker 48 which provides secondary protection is commonly referred to as a tie breaker, whereas its associated relay 54 is commonly referred to as a coupler, tie or transfer relay. The terms “coupler relay”, “tie relay” and “transfer relay” have been used interchangeably herein in the description of prior art systems and in the detailed description of the multiple embodiments of the claimed invention.

In the arrangement of FIG. 1, circuit breaker 26 and its associated protective relay 24 have been taken out of service, while line 32 remains energized and in service. Line 32 is protected by circuit breaker 48 and associated protective relay 54. Furthermore, as shown in FIG. 1, primary circuit breaker 22 and line 30, and all other lines connected into substation 28, remain in service.

Nevertheless, the arrangement of FIG. 1 poses a number of challenges for the tie relay 54. For example, transmission lines 30 and 32 often have different properties requiring each associated local relay 20 and 24 to be configured for that particular line. Because it provides for secondary protection for transmission lines 30 and 32 and potentially for every other line (not shown) connected to substation 28, tie relay 54 must also be adaptable and configurable to emulate the protection provided by local relay 20 and 24, at least in part. Accordingly, when a circuit breaker and its associated relay are isolated or taken out of service, the tie relay must be reconfigured. This is especially a challenge if substation 28 comprise more than the two transmission lines shown in FIG. 1.

More specifically, in order to provide secondary protection, if the tie relay 54 is an electromechanical relay, the transformer ratio of the potential transformer which provides voltage signals to the tie relay 54 is often manually adjusted. The reach or sensitivity of the tie relay 54 would thereby be adjusted in order to change the effective protection characteristics of the tie relay 54 in order to adapt it to the different property characteristics of the transmission lines and thereby emulate local relay 20 and 24. Other methods exist for allowing the tie relay 54 to emulate the protection provided by relays 20 and 24 during breaker bypass operations, such as the methods and systems described by U.S. Pat. Nos. 5,041,737 and 5,132,867.

The arrangement of FIG. 1 and other traditional arrangements create other challenges especially if local relays 20 and 24 are adapted to communicate with remote protective relays located at the opposite end(s) of lines 30 and 32. This communication via communication links 34 and 36 may be generally achieved by transferring data streams or communication signals as described in U.S. Pat. No. 5,793,750 for “System for Communicating Output Function Status Indications Between Two or More Power System Protective Relays” and U.S. patent application Ser. No. 09/900,098 for “Relay-to-Relay Direct Communication System in an Electric Power System,” both of which are incorporated herein in their entirety and for all purposes. Examples of arrangements wherein relays are adapted to communicate with each other include those specified in the above patent and patent application, and also in current differential, charge comparison, phase comparison, or similar relay arrangement. When a circuit breaker is bypassed, such as circuit breaker 26 in FIG. 1, the tie relay 54 is unable to provide protection for line 32 with the same effectiveness as relay 24 did before the bypass operation. This is because protective relay 54 is not in communication with the remote relay at the other end(s) of line 32.

This challenge has been overcome by employing a device to manage data streams between primary local relays 20, 24, remote protective relays 60, 62 positioned at the opposite end(s) of lines,30, 32 and tie relay 54 as shown in FIG. 2. An example of a data stream management device 56 that may be used in this particular arrangement is the SEL-2100 Logic Processor manufactured by Schweitzer Engineering Laboratories, Inc. Generally, the data stream management device 56 receives serial data streams from each local relay 20, 24, tie relay 54, and from the remote relays 60, 62 positioned at the opposite end(s) of lines 30, 32; decodes each data stream into bits of data; stores the decoded data; and executes a programmable logic equation with the decoded data in order to create transmit bits for each outgoing data stream.

The data stream management device 56 is further configured to respond to contact inputs 58. Contact inputs 58 are contact sensing circuits, wherein closure of a contact energizes a contact input 58 to the data stream management device 56 to send bits of information to the data stream management device 56. In this arrangement, the information sent to the data stream management device 56 includes information regarding which primary circuit breaker 22, 26 is to be bypassed in order to isolate it or take it out of service.

In response thereto, the data stream management device 56 appropriately evaluates programmable logic equations which create new transmit bits for each data stream to each of the local protective relays 20, 24, tie relay 54, and the remote protective relays 60, 62 at the opposite end(s) of transmission lines 30, 32. The programmable logic equations are selected such that they normally (when no breaker is bypassed in substation 28) essentially map bits received from the relays positioned at the opposite end(s) of lines 30 and 32 to local relays 20 and 24. During a breaker bypass operation, such as the bypass operation in FIG. 2 which bypasses circuit breaker 26, the programmable logic equations essentially map bits received from one of the relays positioned at the opposite end(s) of either line 30 or 32, or any other line terminating in substation 28, to tie relay 54.

For example, when breaker 26 is bypassed, contact inputs 58 to data stream management device 56 cause programmable logic equations to map bits received from tie relay 56 to the transmit bits delivered to the remote relay 62 at the opposite end of line 32. Likewise, when breaker 26 is bypassed, contact inputs to data stream management device 56 cause programmable logic equations to essentially map bits received from the remote relay 62 at the opposite end of line 32 to the transmit bits delivered to the tie relay 54. Nevertheless, during rerouting of each data stream, reconfiguration of the data stream management device 56 generally interrupts all communications links associated therewith.

The data stream management device 56 may further be connected to a multiplexed network or multiplexer 64 which allows data streams from several local relays 20, 24 in substation 28 to be delivered to remote relays 60, 62 at the opposite ends of lines 30, 32 with a single communications link. Fiber optic modems 66a, b, c, d are further provided between the multiplexer 64 and the data stream management device 56. The fiber optic modems 66a, b, c, d further provide for an optical, rather than an electrical, connection therebetween. The fiber optic modems 66a, b, c, d provide electrical isolation between multiplexer 64 and data stream management device 56, and thereby allows for the data stream management device 56 and the multiplexer 64 to operate on different power sources. The use of fiber optic modems in this manner is often cumbersome.

Nevertheless, providing secondary protection in a communication assisted arrangement as shown in FIG. 2 causes a delay in the transfer of data between the primary local relays 20, 24, primary remote relays 60, 62, and the tie relay 54. More specifically, as discussed above, the data stream management device 56 receives serial data streams from each local relay 20, 24, tie relay 56, and remote relay 60, 62; decodes each data stream into bits of data; stores the decoded data bits; and executes a programmable logic equation operating on the bits of data decoded from each data stream in order to create transmit bits for each data stream. The length of time to complete this process, wherein data is transferred from remote relays 60, 62 to either primary local relay 20, 24 or to the tie relay 56, is generally greater than 8 ms. Because there may be yet another data stream management device 56 located at the opposite end of line 30, and perhaps at the opposite end of line 32, the total delay in transmitting data may be greater than 16 ms. Any delay in transferring data is undesirable when protecting electrical power systems.

Accordingly, it is an object of this invention to provide a method and apparatus including a data stream management system, which introduces delay on the order of microseconds when routing data from primary remote relays to primary local relays or tie relays. It is further an object of this invention to provide a method and apparatus including a data stream management system, wherein reconfiguration thereof does not generally interrupt all communication links associated therewith. It is also an object of this invention to reduce the number of, or eliminate, fiber optic modems associated with a data stream management device. It is further an object of this invention to enable monitoring of the entire communications link and not just the link between a relay and a data stream management device such as that shown in FIG. 2.

These and other desired benefits of the preferred embodiments, including combinations of features thereof, of the invention will become apparent from the following description. It will be understood, however, that a process or arrangement could still appropriate the claimed invention without accomplishing each and every one of these desired benefits, including those gleaned from the following description. The appended claims, not these desired benefits, define the subject matter of the invention. Any and all benefits are derived from the multiple embodiments of the invention, not necessarily the invention in general.

### SUMMARY OF THE INVENTION

In accordance with the invention, an intelligent electronic device for protection, monitoring, controlling, metering or automation of lines in an electrical power system is provided. The intelligent electronic device is adapted to communicate with a variety of other intelligent electronic devices. In one embodiment, the intelligent electronic device includes a communication configuration setting configured to allow communication with one of the other intelligent electronic devices. An input element is further provided in communication with the communication configuration setting, whereupon a signal from the input element selects a particular communication configuration setting therein, thereby allowing for communication with one of the other intelligent electronic devices.

In accordance with another embodiment of the invention, a data stream management device for routing data streams among a plurality of intelligent electronic devices is further provided. The data stream management device generally includes an input for receiving a data stream from a first intelligent electronic device. A router is further provided for routing the data stream from the first intelligent electronic device to a second intelligent electronic device, wherein the routed data stream is in a substantially unaltered form from that of its received form. The data stream management device further includes an input element in communication with the router, whereupon a signal from the input element routes the data stream received by the first intelligent electronic device to a third intelligent electronic device. This routed data stream is further in a substantially unaltered form from that of its received form.

Upon a signal from an input element to the third intelligent electronic device, a particular communication configuration setting in the third intelligent electronic device is selected to allow for communication with one of the other intelligent electronic devices.

In accordance with yet another embodiment of the invention, a system for protection, monitoring, controlling, metering or automation of lines in an electrical power system is provided. The system includes a data stream management device for routing data streams among intelligent electronic devices associated with the electrical power system, and an intelligent electronic device associated with the data stream management device. The intelligent electronic device is adapted to communicate with the other intelligent electronic devices. The intelligent electronic device further includes a communication configuration setting configured to allow communication with one of the other intelligent electronic devices and an input element in communication with the communication configuration setting, whereupon an assertion of the input element selects a particular communication configuration setting therein. This selection of a particular communication configuration setting allows for communication with one of the other intelligent electronic devices.

In accordance with yet another aspect of the invention, a method for routing communication signals in an electrical power system is provided including the steps of receiving a data stream from a first intelligent electronic device, routing the data stream from the first intelligent electronic device to a second intelligent electronic device, wherein the routed data stream is in a substantially unaltered form from that of its received form, and routing the data stream received by the first intelligent electronic device to a third intelligent electronic device upon signaling from an input element, wherein the routed data stream is in a substantially unaltered form from that of its received form.

It should be understood that the present invention includes a number of different aspects or features which may have utility alone and/or in combination with other aspects or features. Accordingly, this summary is not exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE DRAWINGS

FIG. 1 is a single line schematic diagram of a prior art substation of a power system including a tie relay and associated elements for secondary protection of the primary power system elements related thereto.

FIG. 2 is a single line schematic diagram of the substation of FIG. 1 including a prior art data stream management device and alternatively a data stream management device according to an embodiment of the invention.

FIG. 3 is front view of the data stream management device according to an embodiment of the invention.

FIGS. 4a, b, c, d, e, and f are illustrative diagrams of the data stream flow indicator and the data stream direction indicators of the data stream management device of FIG. 3 in use in various situations.

FIG. 5 is rear view of the data stream management device of FIG. 3.

FIG. 6 is a block diagram of the data stream management device of FIG. 3.

FIG. 7 is a block diagram of a protective relay according to an embodiment of the invention.

FIG. 8 is a single line schematic diagram of a secondary protection arrangement including the data stream management device of FIG. 3 for routing protective devices having dissimilar communication means.

FIG. 9 is a single line schematic diagram of a secondary protection arrangement including the data stream management device of FIG. 3 for supporting primary and backup communication channels.

FIG. 10 is a single line schematic diagram of a testing arrangement including the data stream management device of FIG. 3.

FIG. 11 illustrates the mapping by a data stream management system according to another embodiment of the invention.

FIG. 12 illustrates the mapping by a data stream management system according to another embodiment of the invention.

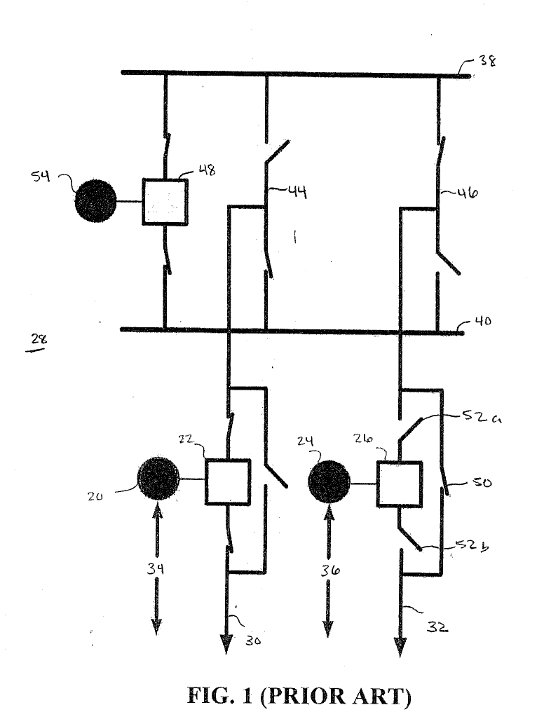

### DETAILED DESCRIPTION OF THE INVENTION

The present invention generally relates to a method and apparatus for customization of an IED. Generally, IEDs are used for protecting, monitoring, controlling, metering and/or automating electric power systems and associated transmission lines. IEDs may include protective devices such as protective relays, or otherwise, RTUs, power line communication device, bay controllers, SCADA systems, general computer systems, meters, and any other comparable devices used for protecting, monitoring, controlling, metering and/or automating electric power systems and their associated transmission lines.

Protective devices generally include various overcurrent, voltage, directional, distance, differential, and frequency protective logic schemes. In accordance with an aspect of this invention, these logic schemes and the logic elements associated therewith are generally either programmed into user programmable memory, programmed into programmer programmable memory, or permanently hard coded into fixed memory.

Although the embodiments described herein are preferably associated with protective devices, such as protective relays, it is contemplated that the embodiments may also be associated with any suitable power system control or protective devices such as those described above or below

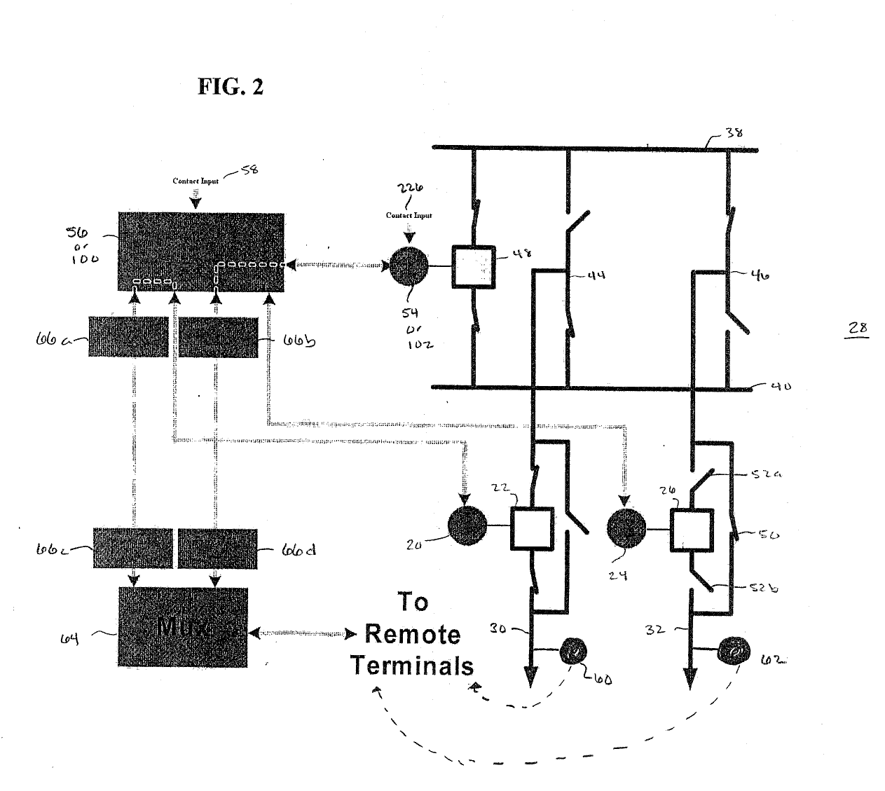

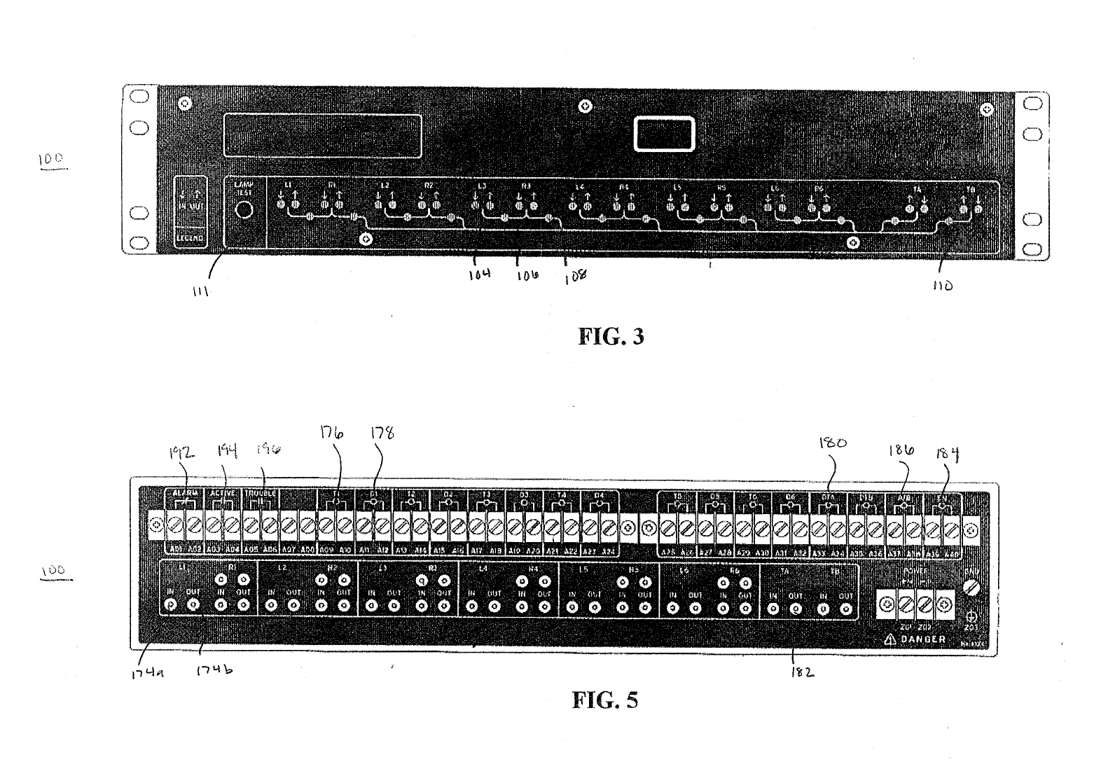

In one embodiment, a data stream management device 100 is provided as shown in FIG. 3. The data stream management device 100 may be used in place of the prior art data stream management device 56 of FIG. 2.

In this embodiment, the data stream management device 100 is adapted to route data streams in their unaltered form. As such, any data stream received by the data stream management device 100 is transmitted in its unmodified form. In order to handle the delay of routing data streams as described above, data streams transmitted from the data stream management device 100 are routed to a protective relay in the form of tie relay 102. The tie relay 102 includes communication configuration parameters, such as channel addresses, which are altered via some input source such as a contact input in order to allow for communication with another protective device. More specifically, tie relay 102 may be used in place of prior art tie relay 54. In order to allow communication with other protective devices, tie relay 102 includes communication configuration settings that are changed via signaling from input elements associated therewith. In the embodiment as shown in FIG. 2, the input elements are contact inputs 226, which will be discussed in greater detail below.

It shall be noted that prior art tie relay 54 is not associated with contact inputs 104 for changing communication configuration settings therein. Rather, a protective device including an input element in communication with a communication configuration setting as discussed herein in an aspect of an invention first taught in this patent application.

Now referring to FIG. 3, the data stream management device 100 generally includes indicators for displaying where data streams are being routed. The indicators in this embodiment include a plurality of LED's for displaying data stream flow and direction. In this figure, each number represents ports. For example, L1 and R1 represent local and remote connections to Port 1, whereupon a local relay (L1) and remote relay (R1) is connected. For example, L1 may correspond to local relay 20 and R1 may correspond to remote relay 60 of FIG. 2. TA and TB represent ports associated with a first and second tie or transfer relay. For example, TA may correspond with tie relay 102 of FIG. 2. The “up” arrow represents transmit, whereas the “down” arrow represents receive.

The data stream management device 100 further includes status indicators for displaying where the data streams are being routed. In this embodiment as shown in FIG. 3, these status indicators include a set of data stream flow indicators and a set of data stream direction indicators.

The set of data stream flow indicators (for example, the LED at 104) indicate if data is being transmitted and/or received at each data port. In this embodiment, this set of indicators is the top row of LED's on the front panel of the data stream management device 100. For purposes of this embodiment, communication among protective devices may be generally achieved by transferring data streams or communication signals as described in U.S. Pat. No. 5,793,750 for “System for Communicating Output Function Status Indications Between Two or More Power System Protective Relays” and U.S. patent application Ser. No. 09/900,098 for “Relay-to-Relay Direct Communication System in an Electric Power System.”

In view of such, when a data stream flow indicator (for example, the LED at 104) is illuminated as a first color, data is being transmitted and received through the associated data port. When the data stream flow indicator (for example, the LED at 104) is illuminated as a second color, data is being transmitted but not received through the associated data port. These indicators are further illuminated as the second color when the data port is disabled via signaling of a binary input.

The data stream management device 100 may further be adapted to manage communication means other than that described in U.S. Pat. No. 5,793,750 and U.S. patent application Ser. No. 09/900,098. As such, the data stream flow indicator (for example, the LED at 104) would be adapted to indicate data flow through the associated data port.

The data stream management device 100 further includes a set of data stream direction indicators (for example, the LED at 106), which indicate where data is being transmitted and/or received. In this embodiment, this set of indicators is the second row of LED's on the front panel of the data stream management device 100. When a data port is either connected to a primary local or remote relay (20, 24, 102 of FIG. 2) and when at least one of the associated data stream flow indicators (for example, the LED at 104) is illuminated to the first color signaling either transmission or receipt of data, the associated primary data stream direction indicator (for example, the LED at 106) is also illuminated. When a data port is connected to a tie relay (102 of FIG. 2) and when at least one of the associated data stream flow indicators is illuminated (for example, the LED at 108) to the first color signaling either transmission or receipt of data, the associated secondary data stream direction indicator (for example, the LED at 110) is also illuminated. If the data port is not connected to a primary local relay 20, 24, a primary remote relay 60, 62, or a tie relay 102, the associated data stream direction indicators (for example, the LED at 106) remain unlit. Furthermore, if two ports are rerouted, the data stream direction indicator (for example, the LED at 108) associated with the higher number port is adapted to flash at a different rate than an indicator associated with the lower numbered port.

The data stream management device 100 further includes a testing mechanism operable to test the operational status of the data stream status indicators. In this embodiment, activation of the testing mechanism 111 illuminates all LED's on the front panel to allow for testing of the functionality thereof. The data stream management device 100 further includes an indicator (not shown) for displaying whether the data stream management device 100 is enabled. In view of the above, the LED's as described herein may be replaced by other suitable display means without deviating from the spirit of the invention. For example, an LCD may be used in place of the LED's as a data stream flow and direction indicator.

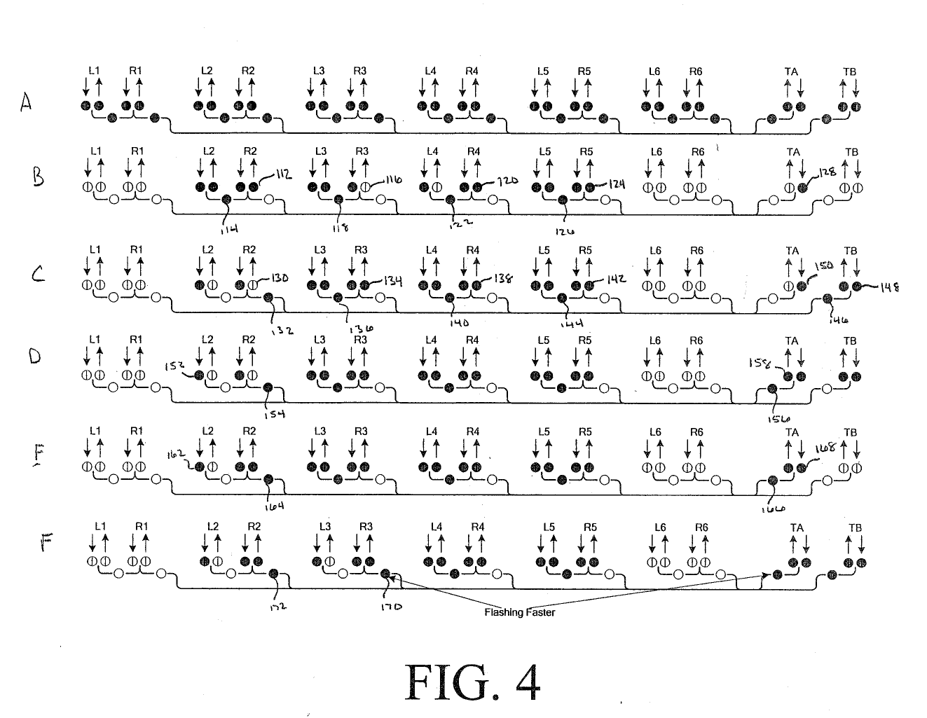

FIG. 4 illustrates examples of the status indicators of the embodiment of FIG. 3 in use in various situations. FIG. 4A illustrates the indicator coloration when the testing mechanism 111 of FIG. 3 is activated, whereupon all LED's are illuminated.

In FIG. 4B, ports 1 and 6 are unused as indicated by the LED's associated therewith being unlit. The data stream flow indicator 112 for port 2 is shown as being illuminated as a second color in order to display that a contact input has disabled this port. The primary data stream direction indicator 114 is shown as being illuminated as the primary local relay L2 is in communication with primary remote relay R2.

The receive portion of primary local relay (L3) of data stream flow indicator 116 for port 3 is illuminated as a second color indicating that port L3 is transmitting but not receiving data. The transmit portion of the primary remote relay (R3) remains unlit. The primary data stream direction indicator 118 is further illuminated. This illumination arrangement indicates that primary local relay (L3) is connected to primary remote relay (R3), but primary local relay (L3) is not receiving data for to transfer to port R3.

The receive portion of primary remote relay (R4) of data stream flow indicator 120 for port 4 is illuminated as a second color indicating that port R4 is transmitting but not receiving, whereas the transmit portion of the primary local relay (L4) remains unlit. The primary data stream direction indicator 122 is further illuminated. This illumination arrangement indicates that primary remote relay (R4) is connected to primary local relay (L4), but primary remote relay (R4) is not receiving data for such.

Both the receive and transmit portions of primary remote relay (R5) of data stream flow indicator 124 for port 5 are illuminated as a first color.

Furthermore, both the receive and transmit portions of primary local relay (L5) of the data stream flow indicator 120 for port 5 are illuminated as a first color. The primary data stream direction indicator 122 is further illuminated.

This illumination arrangement indicates that primary remote relay (R5) is connected to primary local relay (L5), wherein both relays are receiving and transmitting data with one another.

The receive portion of the data stream flow indicator 128 for the tie relay port (TA) is illuminated as a first color, thereby indicating that data is being received by that port.

In FIG. 4C, ports 1 and 6 are unused as indicated by the LED's associated therewith being unlit. As in port 5 in FIG. 4B, both the receive and transmit portions of primary remote relays (R3, R4, R5) of data stream flow indicators 134, 138, and 142 for ports 3, 4, and 5 are illuminated as a first color. Furthermore, both the receive and transmit portions of primary local relays (L3, L4, L5) of the data stream flow indicator 134, 138, 142 for ports 3, 4 and 5 are illuminated as a first color. The primary data stream direction indicators 136, 140, and 144 are further illuminated. This illumination arrangement indicates that primary remote relays (R3, R4, and R5) are respectively connected to primary local relays (L3, L4, and L5), wherein both relays are receiving and transmitting data with one another.

Both receive portions of primary local and remote relays (L2, R2) of the data stream flow indicator 130 for port 2 are illuminated as a first color. Furthermore, a secondary data stream direction indicator 132 is illuminated showing communication with a tie relay. Accordingly, this secondary data stream direction indicator 132 corresponds with the illumination of the data stream direction indicator 146 of tie relay (TB). The transmit portion of data stream flow indicator 148 is illuminated as a first color, thereby indicating that tie relay (TB) is transmitting data. Nevertheless, the receive portion of data stream flow indicator 148 for tie relay (TB) is illuminated as a second color, thereby indicating that tie relay (TB) is transmitting but not receiving data. On the other hand, the receive portion of the data stream indicator 150 is illuminated as a first color, which would indicate that the data stream management device is routing data to the wrong transfer port (i.e. it should be routing data to TA, but instead it is routing data to TB).

In FIG. 4D, like FIGS. 4B and 4C, ports 1 and 6 are unused as indicated by the LED's associated therewith being unlit. Like FIG. 4C, ports 3, 4, and 5 comprise primary relays which are correctly in communication with one another.

Both receive portions of primary relays (L2, R2) of the data stream flow indicator 152 for port 2 are illuminated as a first color. Furthermore, a secondary data stream direction indicator 154 is illuminated showing communication with a tie relay. Accordingly, this secondary data stream direction indicator 154 corresponds with the illumination of the data stream direction indicator 156 of tie relay (TA). Both the transmit and receive portion of data stream flow indicator 158 for tie relay (TA) are further illuminated as a second color, thereby indicating that tie relay port (TA) is disabled by contact input. Moreover, both the transmit and receive portion of data stream flow indicator 160 for tie relay (TB) are further illuminated as a second color, thereby indicating that tie relay port (TB) is disabled by contact input. In this case, R2 is rerouted to TA, but TA is disabled so R2 has nothing to transmit.

In FIG. 4E, like FIGS. 4B, 4C and 4D, ports 1 and 6 are unused as indicated by the LED's associated therewith being unlit. Like FIG. 4C and 4D, ports 3, 4, and 5 comprise primary relays which are correctly in communication with one another.

Both receive portions of primary local and remote relays (L2, R2) of the data stream flow indicator 162 for port 2 are illuminated as a first color. Furthermore, a secondary data stream direction indicator 164 is illuminated showing communication with a tie relay. Accordingly, this secondary data stream direction indicator 164 corresponds with the illumination of the data stream direction indicator 166 of tie relay (TA). Both the transmit and receive portion of data stream flow indicator 168 for tie relay (TA) are further illuminated as a first color, thereby indicating that tie relay (TA) is correctly receiving and transmitting data from primary remote relay R2.

In FIG. 4F, like FIGS. 4B, 4C, 4D and 4E, ports 1 and 6 are unused as indicated by the LED's associated therewith being unlit. Like FIG. 4C, 4D and 4E, ports 4 and 5 comprise primary relays which are correctly in communication with one another.

In this figure, the relays associated with ports 2 and 3 are rerouted to the ports associated with tie relays TA and TB. As such, the data stream direction indicator 170 associated with the higher number port is adapted to flash at a different rate than an indicator 172 associated with the lower numbered port. In this particular embodiment, indicator 170 is adapted to flash faster than indicator 172. Likewise, the data stream direction indicator for port TA flashes faster than the data stream direction indicator for port TB, thereby indicating that port R3 is routed to port TA, and port R2 is routed to port TB.

Now referring to FIG. 5, the data stream management device 100 includes a plurality of transmit and receive inputs and outputs for various ports. In this figure, the inputs and outputs are shown as being fiber optic connections (for example, the fiber optic “in” or receive connection at 174a and the fiber optic “out” or transmit connection at 174b), although other comparable types of connections may be used without deviating from the spirit of the invention. Each number represents ports. For example, L1 and R1 represent local and remote relay connections in Port 1. TA and TB represent ports associated with a first and second tie or transfer relay. Each port corresponds with the status indicators of FIG. 3. Now referring back to FIG. 5, each “in” connection represents a receive connection, whereas the “out” connection represents a transmit connection. These connections respectively correspond to the “down” and “up” arrows of FIG. 3.

The data stream management device 100 further includes input elements in communication with a router as will be described in further detail below. The data stream management device is adapted such that upon a signal from an input element, the data stream received by a protective device is routed to another protective device. Although other input elements such as commands to a serial port may be used, the input element as shown in this embodiment is a contact input. In this embodiment, contact input T1 (176), for example, is associated with the transmit and receive connections of Port 1. When contact input T1 176 is asserted, the connection between R1 and L1 is broken, and R1 is rerouted to either tie relay port TA, TB. When contact input D1 (178) is asserted, the transmit and receive connections 174a and 174b for Port 1 are disabled. Subsequent pairs of contact inputs T2 through T6 and D2 through D6 operate in a similar fashion to contact inputs T1 and D1, respectively. Moreover, when contact input DTA (180) is asserted, the transmit and receive connections 182 and 183 port TA are disabled. DTB operates in a similar fashion to DTA, except it disables transmit and receive connections for port TB.

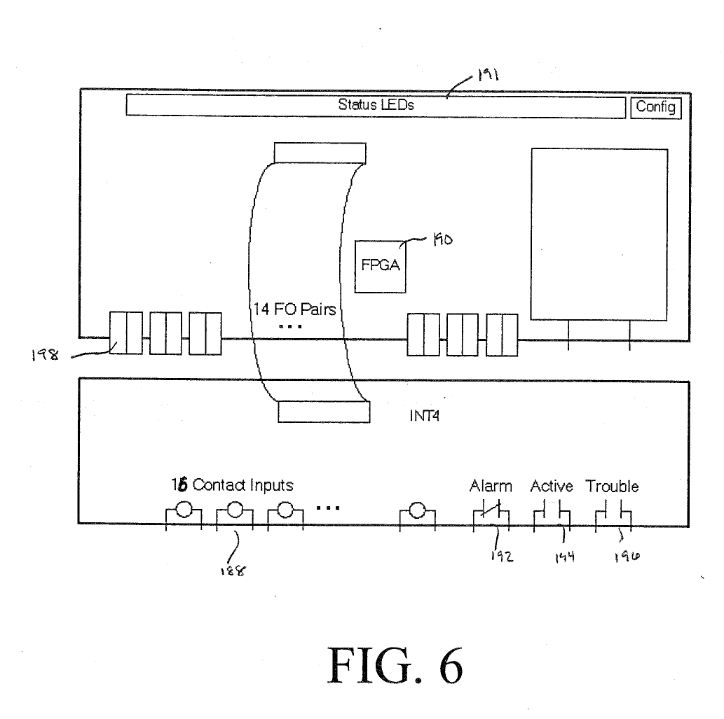

As shown in FIGS. 6, an input element is provided for enabling all inputs of the data stream management device 100. In the embodiment of FIGS. 6. As shown in FIG. 5, assertion of contact input EN (184) enables all ports. If contact input EN is deasserted, depending on the configuration of a jumper or switch, all of the ports cease functioning. The data stream management device 100 is further adapted such that even when contact input EN (184) does not disable the transmit connections, each local and transfer or tie port may be disabled with an associated contact input D1 through D6, DTA and DTB.

Contact input A/B (186) provides for selection between tie relay A and tie relay B. When it is asserted, any bypass operations involve tie relay B. Otherwise, bypass operations involve tie relay A, unless both tie ports are used simultaneously.

As shown in FIG. 6, the status of the contact inputs 188 (i.e., 176, 178, 180, 184, 186 of FIG. 5) as described above may be routed to a field-programmable gate array 190 (FPGA) for data routing. Alternatively, a suitable complex programmable logic device (CPLD), or any other suitable device may be used in this application. In this embodiment, the FPGA is further adapted to monitor the activity of the contact inputs and the transmit and receive data on each port 198. In turn, the FPGA is adapted to control the front panel display and indicators (in this embodiment, LED's 191) described above in response thereto.

An output element adapted for signaling an alarm condition is further provided. For example, in the embodiment of FIGS. 5 and 6, an alarm contact output 192 is provided in order to signal any alarm conditions. Alarm contact output 192 remains open whenever the FPGA 190 is configured properly, and whenever the ports are not disabled via contact input EN. A contact output 194 is further provided to indicate when one of the disable contact inputs D1-D6, DTA, or DTB or transfer contact inputs T1 through T6 are asserted. An output element adapted for signaling when a problem is detected with an associated input is further provided. For example, in the embodiment of FIGS. 5 and 6, a contact output 196 is provided to assert when an illegal combination of inputs is asserted or when a problem is detected with one of the ports. Contact output logic 200 is further coupled thereto to signal such.

As briefly discussed above, in this embodiment, the data stream management device 100 is adapted to route data stream signals in their substantially unaltered form via a router. Any data stream in the form of a waveform received by the data stream management device 100 is transmitted in its substantially unmodified form. As such, the FPGA does not decode, decipher, or otherwise interpret the data stream received on any port. Instead, the FPGA replicates the received waveform on the appropriate port and transmits it to an appropriate relay without substantially any modification thereto.

In order to allow communication with other protective devices, tie relay 102 includes communication configuration settings that are changed via signaling from input elements associated therewith. More specifically, communication configuration settings in the tie relay are changed via contact inputs associated therewith. As such, when the settings of the tie relay are modified to protect an associated line, the communication configuration settings therein are also modified such that the tie relay can communicate with the appropriate corresponding primary relay.

In prior art tie relays, there is generally a plurality of groups of transmission line settings corresponding to the parameters associated with the protection of each separate transmission line associated therewith. Nevertheless, there is traditionally only one group of communication configuration settings. In accordance with the teachings of this invention, a plurality of communication configuration settings are associated with contact inputs such that communication configuration settings may be changed from contact inputs.

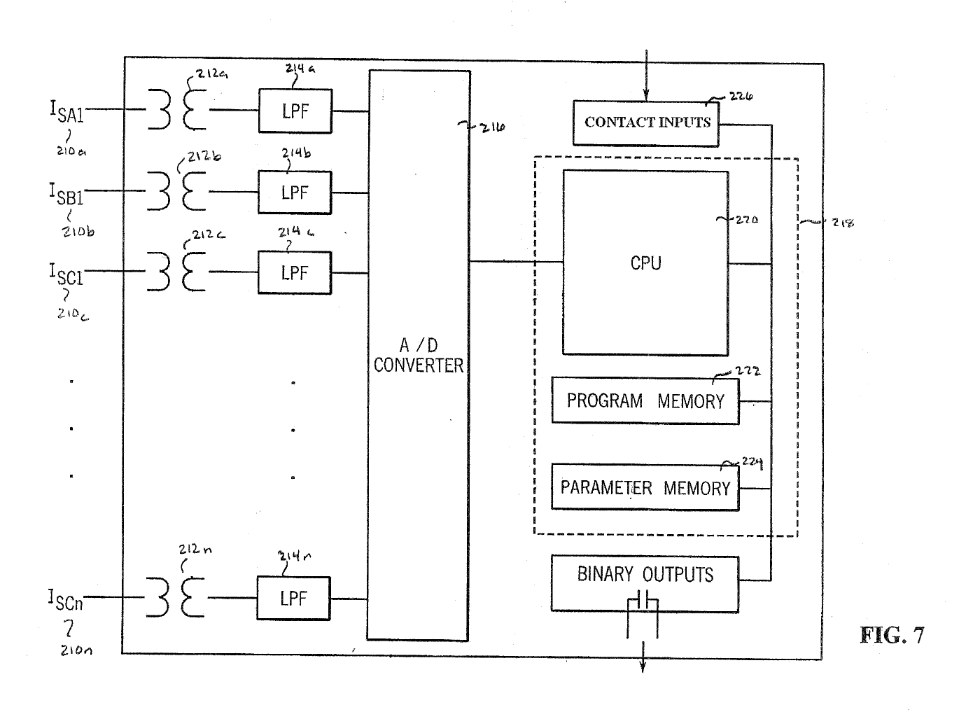

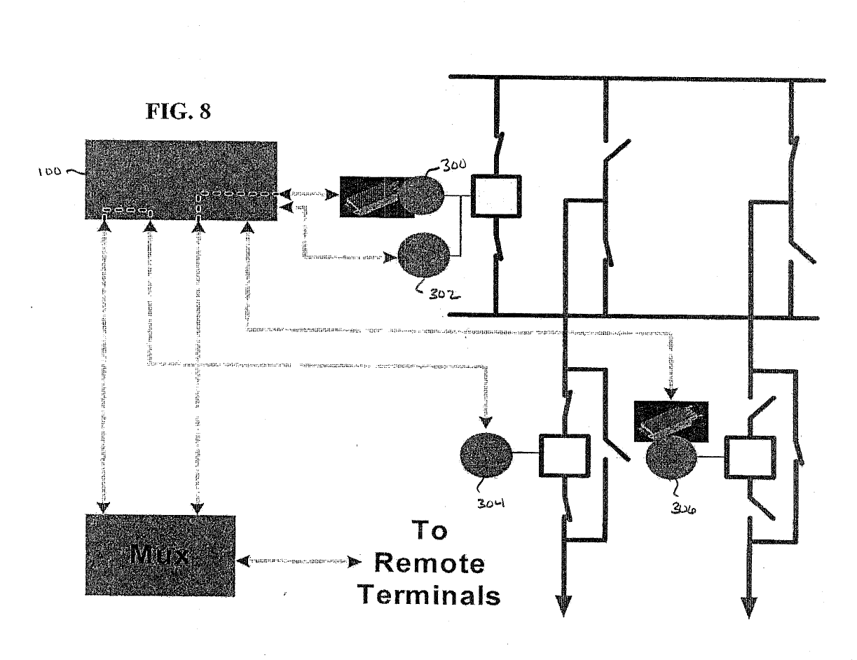

FIG. 7 is a block diagram of a protective relay 102 which may be used with the data stream management device 100. During operation, the secondary current waveforms 210a to 210n received by the protective relay 102 are further transformed into corresponding current waveforms via respective current transformers 212a to 212n and resistors (not separately illustrated), and filtered via respective analog low pass filters 214a to 214n. An analog-to-digital (A/D) converter 216 then multiplexes, samples and digitizes the filtered secondary current waveforms to form corresponding digitized current sample streams (e.g., 1011001010001111).

The corresponding digitized current sample streams are received by a microcontroller 218, where they are digitally filtered via, for example, a Cosine filter to eliminate DC and unwanted frequency components.

In this embodiment, the microcontroller 218 includes a microprocessor, or CPU 220, program memory 222, and parameter memory 224. The traditional relay is adapted to implement overcurrent, voltage, directional, distance, differential, and frequency protective logic schemes. These logic schemes and the logic elements associated therewith are generally either programmed into the program memory 222 or permanently hard coded into parameter memory 224. The microprocessor 134 is coupled to the program memory 222 and the parameter memory 224 so that it may access the logic schemes and logic elements associated therewith in order to perform various protective functions. Associated with or residing in the program memory 222 and the parameter memory 224 are communication configuration settings. The communication configuration settings are configured to allow communication with other protective devices. Among the communication configuration settings include channel address settings, parity settings, data rate settings, word length settings, internal or external timing source settings, settings to configure the communications port as data terminal equipment (DTE) or data communications equipment (DCE), settings to invert the polarity of the transmitted data, settings to select what protocol is used to carry various pieces of information, and settings to modify or select the modulation technique used to name a few.

Microcontroller 218 is also adapted to receive signals via input elements. In this embodiment, the input elements are in the form of contact inputs 226 from other external devices such as protective devices or external computers. Similar input elements such as commands from an associated serial port may also be used. The input element is in communication with the communication configuration setting, whereupon a signal from the input element selects a particular configuration setting therein. The selection of a particular configuration setting allows for communication with a particular protective device.

In another embodiment, particular groups of protections settings are associated with the protection, monitoring, controlling, metering or automation of different transmission lines. In turn, each group of protection settings may further be associated with a communication configuration setting. An assertion of an input element (for example, a contact input) selects a group of protection settings, thereby selecting a communication configuration setting associated therewith.

In describing the use of the different embodiments of the protective relays in accordance with the teachings of this invention, the data stream management device 100 may be used in place of the data stream management device 56 of FIG. 2. In view of such, a protective relay 102 in accordance with the teachings of the invention may be used in place of the tie relay 54 of FIG. 2. The protective relay 102 is adapted to communicate with primary local 20, 24 or remote 60, 62 relays to provide for communication assisted protection as shown in FIG. 2.

Generally, the data stream management device 100 receives, reroutes and transmits the data streams from each relay 20, 24, 60, 62, 102 in substantially unaltered form. Accordingly, the FPGA of the data stream management device 100 does not decode, decipher, or otherwise interpret the data stream received on any port. Instead, the FPGA replicates the received waveform on the appropriate port and transmits it to an appropriate relay without any modification thereto.

The data stream management device 100 is further configured to respond to contact inputs 58. Contact inputs 58 are contact sensing circuits, wherein closure of a contact energizes a contact input 58 to the data stream management device 56 to send bits of information to the data stream management device 56. The contact inputs may involve a number of operations including those discussed above.

In one specific example of such, upon asserting an appropriate contact input, information is sent to the data stream management device 100, which includes information regarding which primary circuit breaker 22, 26 is to be bypassed in order to isolate it or take it out of service. In response thereto, the data stream management device 100 appropriately routes each data stream in order to provide for secondary protection by tie breaker 48 and protective relay 102.

Upon an assertion of a contact input 226 related thereto, the protective relay 102 reconfigures the communication configuration settings which may or may not be associated with the protection settings of the transmission line corresponding to the circuit breaker and relay to be bypassed. As such, when the settings of the tie relay are modified to protect the associated transmission line, the communication configuration settings therein are also modified such that the tie relay may communicate with the appropriate corresponding relay.

In another embodiment as shown in FIG. 8, two tie relays 300, 302 are respectively used to provide secondary protection for primary relays 304, 306 having different communication means. For example, tie relay 300 and primary relay 306 may use the communication means or system as described in U.S. Pat. No. 5,793,750 and U.S. patent application Ser. No. 09/900,098. On the other hand, tie relay 302 and primary relay 304 may use communication means for current differential protection. As such, in order to provide for secondary protection, the data stream management device 100 may be adapted to have two ports for supporting two different tie relays 300, 302 (ports TA and TB in the other figures). On the other hand, a single device may be used in place of the two separate tie relays 300, 302 such as the SEL-311L line current differential protection and automation system manufactured by Schweitzer Engineering Laboratories, Inc.

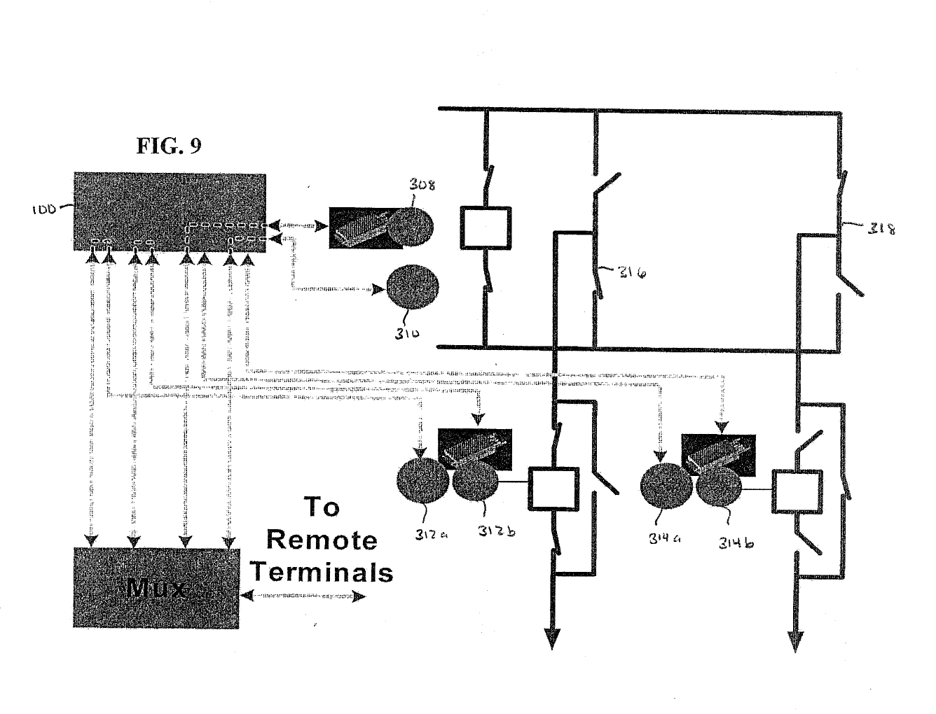

In yet another embodiment as shown in FIG. 9, a plurality of tie relays 308 and 310 may be used to provide secondary protection for a plurality of different primary relays 312, 314 at the same time. In FIG. 9, the circuit breaker associated with primary local relays 314a and 314b is bypassed. Normally both relays 314a and 314b provide protection for the same line. Accordingly the communications management device 100 must reroute communications streams from two remote relays to tie relays 308 and 310 simultaneously. Device 100 is adapted for such a purpose. As discussed above with regards to the embodiment of FIG. 8, each relay may use different communication means. When a plurality of tie relays are used in this manner, the data stream flow indicators may be adapted to flash at different rates depending on the port location as described in detail above.

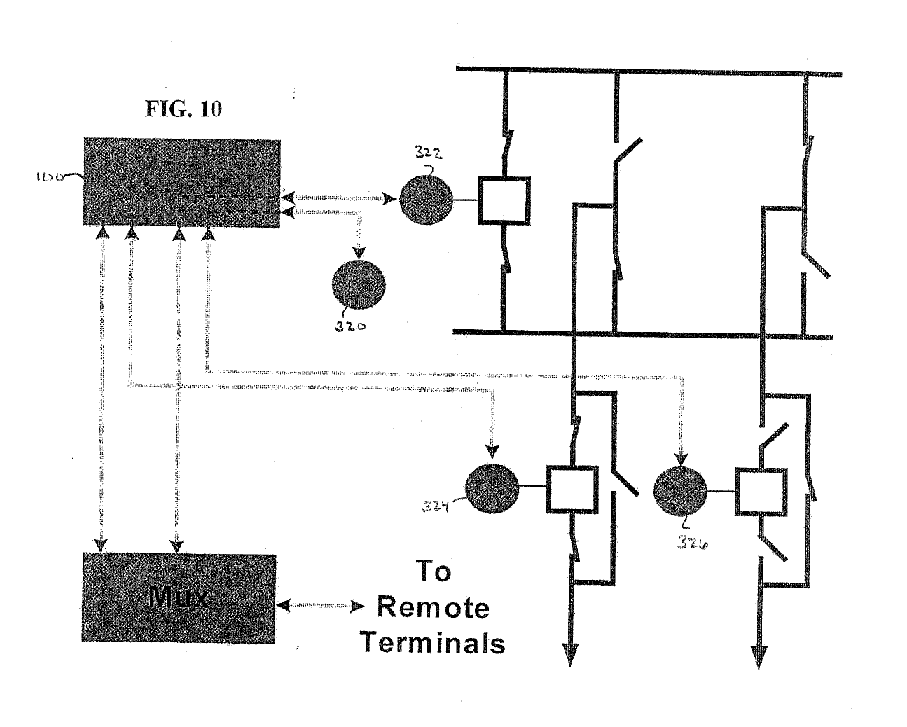

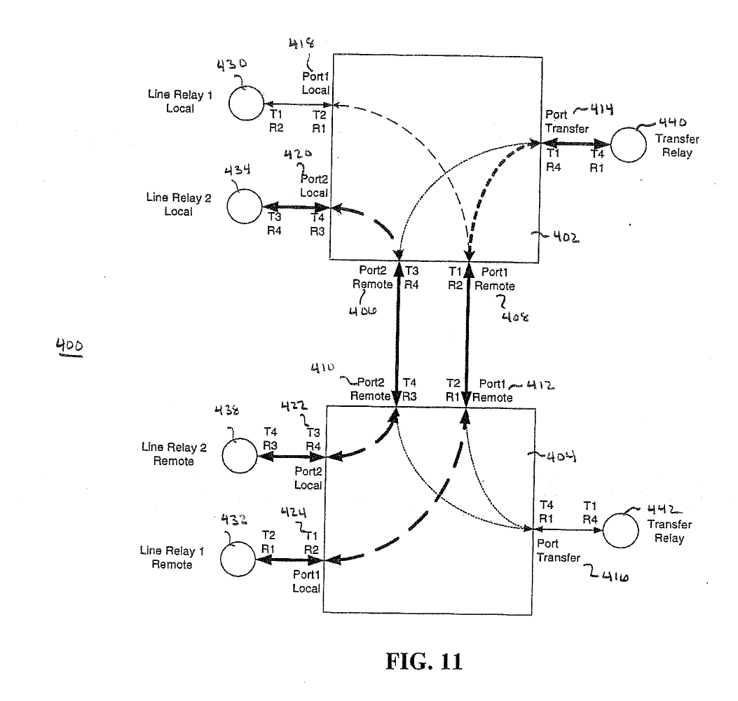

In yet another embodiment as shown in FIG. 10, a test relay 320 may be coupled to the data stream management device 100. In this case, the test relay may be linked via the data stream management device to test any one of the primary relays 324, 326 or the tie relay 322.

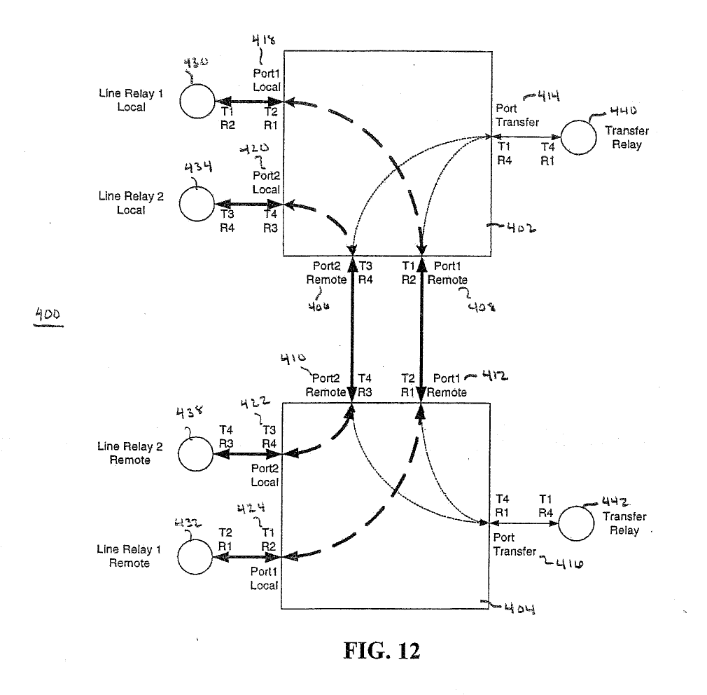

In yet another embodiment as shown in FIGS. 11 and 12, a data stream management system 400 may used in place of the data stream management devices as described above. Unlike the data stream management devices as discussed in the embodiments above, the data stream management system includes two data stream management devices 402, 404. Although this system 400 includes two separate devices, the components of data stream management devices 403, 404 may be incorporated into a single device. In this embodiment, each data stream management device 402, 404 includes a computer processing unit which processes logic in order to perform channel addressing therein. This logic may be configurable to allow a user to control routing of data streams based on selected parameters. More specifically, this logic may be associated with channel addressing as described below.

In order to establish routing logic, a logic equation is implemented for each remote port 406, 408, 410, 412. When the equation evaluates true, data from the remote port 406, 408, 410, 412 is routed to the transfer port 414, 416. When the equation evaluates false, data from the remote port 406, 408, 410, 412 is routed to the associated local port 418, 420, 422, 424.

More specifically, FIG. 12 illustrates the data stream management system 400 during a non-bypass operation. In this case, primary local relay 430 is in communication with primary remote relay 432. Primary local relay 430 sends a communication data stream to data stream management device 402 at local port 418. Upon receipt of a data stream from primary local relay 430, data stream management device 402 implements a logic equation thereto at remote port 408 in order to provide channel addressing for such. This modified data stream is transferred to data stream management device 404 from remote port 408 to remote port 412 of the data stream management device 404. At the remote port 412, the data stream management device 404 evaluates the modified data stream as false, thereby routing it to local port 424 and then to primary remote relay 432.

Likewise, upon receipt of the modified data stream, primary remote relay 432 sends a communication data stream to data stream management device 404 at local port 424. Upon receipt of a data stream from primary local relay 432, data stream management device 404 implements a logic equation thereto at remote port 412 in order to channel address such. This modified data stream is transferred to data stream management device 402 from remote port 412 to remote port 408 of the data stream management device 402. At the remote port 408, the data stream management device 402 evaluates the modified data stream as false, thereby routing it to local port 418 and then to primary remote relay 430.

Primary local relay 434 and primary remote relay 438 operate in a similar fashion with their associated ports during non-bypass operating conditions.

FIG. 11 illustrates the data stream management system 400 during a bypass operation. In this case, primary remote relay 432 is in communication with transfer or tie relay 440. Primary remote relay 432 sends a communication data stream to data stream management device 404 at local port 424. Upon receipt of a data stream from primary remote relay 432, data stream management device 404 implements a logic equation thereto at remote port 412 in order to modify the channel address in order to route communications to remote port 408. This modified data stream is transferred to data stream management device 402 from remote port 41 2 to remote port 408 of the data stream management device 402. At the remote port 408, the data stream management device 402 evaluates the modified data stream as true, thereby routing it to transfer port 414 and then to transfer or tie relay 440.

Likewise, upon receipt of the modified data stream, transfer relay 440 sends a communication data stream to data stream management device 402 at transfer port 414. Upon receipt of a data stream from transfer relay 440, data stream management device 402 implements a logic equation thereto at remote port 408 in order to channel address such. This modified data stream is transferred to data stream management device 404 from remote port 408 to remote port 412 of the data stream management device 404. At the remote port 412, the data stream management device 404 evaluates the modified data stream as false, thereby routing it to local port 424 and then to primary remote relay 432. In a similar manner, the other relays may be rerouted in order to provide secondary protection thereto.

In yet another embodiment, transfer relay 440 sends a communication data stream to data stream management device 402 at transfer port 414 regardless of receipt of a modified data stream.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

What is claimed is:

1. An intelligent electronic device for protection, monitoring, controlling, metering or automation of lines in an electrical power system, wherein said intelligent electronic device is adapted to communicate with a variety of other intelligent electronic devices, comprising:
a communication configuration setting configured to allow communication with one of the other intelligent electronic devices; and
an input element in communication with said communication configuration setting, whereupon a signal from said input element selects a particular communication configuration setting therein, thereby allowing for communication with one of the other intelligent electronic devices.

2. The intelligent electronic device of claim 1, further comprising a group of protection settings associated with the protection, monitoring, controlling, metering or automation of the lines, said group of protection settings being further associated with said communication configuration setting, whereupon an assertion of said input element selects said group of protection settings, thereby selecting the communication configuration setting associated therewith.

3. The intelligent electronic device of claim 1, wherein the input element is a contact input.

4. The intelligent electronic device of claim 1, wherein the input element is a command from a serial port.

5. The intelligent electronic device of claim 1, wherein the intelligent electronic device is a protective device.

6. The intelligent electronic device of claim 1, further comprising a memory allocation for storing said communication configuration setting.

7. The intelligent electronic device of claim 1, wherein said memory allocation is fixed.

8. The intelligent electronic device of claim 1, wherein said memory allocation is programmable.

9. The intelligent electronic device of claim 1, wherein said memory allocation includes other parameter settings.

10. A system for protection, monitoring, controlling, metering or automation of lines in an electrical power system, comprising:
a data stream management device for routing data streams among intelligent electronic devices associated with the electrical power system, and
an intelligent electronic device associated with the data stream management device and adapted to communicate with the other intelligent electronic devices, said intelligent electronic device further including a communication configuration setting configured to allow communication with one of the other intelligent electronic devices and an input element in communication with said communication configuration setting, whereupon an assertion of said input element selects a particular communication configuration setting therein, thereby allowing for communication with one of the other intelligent electronic devices.

11. The system of claim 10, wherein the data stream management device is further adapted to receive a data stream from one of the intelligent electronic devices and transmit the data stream to another intelligent electronic device in a substantially unaltered form.

12. The system of claim 10, wherein said intelligent electronic device further includes a group of protection settings associated with the protection, monitoring, controlling, metering or automation of the lines, said group of protection settings being further associated with said communication configuration setting, whereupon an assertion of said input element selects said group of protection settings, thereby selecting the communication configuration setting associated therewith.

13. The system of claim 10, wherein the input element is a contact input.

14. The system of claim 10, wherein the input element is a command from a serial port.

15. The system of claim 10, wherein the intelligent electronic device is protective device.

16. The system of claim 10, wherein the intelligent electronic device further includes a memory allocation for storing said communication configuration setting.

17. The system of claim 10, wherein the data stream management device further includes a router for routing a received data stream to said intelligent electronic device, wherein the routed data stream is in a substantially unaltered form from that of its received form.

18. The system of claim 17, wherein the data stream management device further includes an input element in communication with said router, whereupon a signal from said input element routes the received data stream to the intelligent electronic device, wherein the routed data stream is further in a substantially unaltered form from that of its received form.

19. The system of claim 10, wherein the intelligent electronic device is a protective relay.

20. The system of claim 19, wherein the protective relay is a tie relay.

21. A method for routing communication signals in an electrical power system, comprising:
receiving a data stream from a first intelligent electronic device,
routing the data stream from the first intelligent electronic device to a second intelligent electronic device, wherein the routed data stream is in a substantially unaltered form from that of its received form, and
routing the data stream received by the first intelligent electronic device to a third intelligent electronic device upon signaling from an input element, wherein the routed data stream is in a substantially unaltered form from that of its received form.

22. The method for routing communication signals of claim 21, further comprising
addressing the received data stream, and
routing the data stream to the second or third intelligent electronic device based upon said addressed data stream.

23. The method of routing communication signals of claim 21, further comprising addressing and routing the received data stream upon signaling from the input element.

24. The method of routing communication signals of claim 21, further comprising
receiving the unaltered data stream by the third intelligent electronic device,
signaling an input element associated with third intelligent electronic device, and
selecting a particular communication configuration setting in the third intelligent electronic device based on said signaling by the input element to allow for communication with one of the other intelligent electronic devices.

25. A data stream management device for routing data streams among a plurality of intelligent electronic devices, comprising:
an input for receiving a data stream from a first intelligent electronic device,
a router for routing the data stream from the first intelligent electronic device to a second intelligent electronic device, wherein the routed data stream is in a substantially unaltered form from that of its received form, and
an input element in communication with said router, whereupon a signal from said input element routes the data stream received by the first intelligent electronic device to a third intelligent electronic device, wherein the routed data stream is further in a substantially unaltered form from that of its received form such that upon a signal from an input element to said third intelligent electronic device, a particular communication configuration setting in said third intelligent electronic device is selected to allow for communication with one of the other intelligent electronic devices.

26. The data stream management device of claim 25, wherein said input element is a contact input.

27. The data stream management device of claim 25, wherein said input element is a command to a serial port.

28. The data stream management device of claim 25, further adapted for communication with a protective device.

29. The data stream management device of claim 28, wherein the protective device is a protective relay.

30. The data stream management device of claim 29, wherein the protective relay is a tie relay.

31. The data stream management device of claim 28, wherein the protective device is associated with a circuit breaker.

32. The data stream management device of claim 25, further comprising status indicators for displaying where the data streams are routed.

33. The data stream management device of claim 32, wherein the status indicators comprise a plurality of LED's.

34. The data stream management device of claim 32, wherein the status indicators are LCD displays.

35. The data stream management device of claim 25, wherein the status indicators include data stream flow indicators.

36. The data stream management device of claim 25, wherein the status indicators include data stream direction indicators.

37. The data stream management device of claim 32, further comprising testing mechanism operable to test the operational status of the indicators.

38. The data stream management device of claim 25, wherein the first intelligent electronic device is a line relay, the second intelligent electronic device is a remote relay, and the third intelligent electronic device is a tie relay.

39. The data stream management device of claim 25, wherein the input is a fiber optic connection.

40. The data stream management device of claim 25, further including an output element adapted for signaling an alarm condition.

41. The data stream management device of claim 25, further including an input element adapted for enabling the input for receiving the data stream from the first intelligent electronic device.

42. The data stream management device of claim 25, further including an output element adapted for signaling when a problem is detected with the input.

43. A data stream management device for routing data streams among intelligent electronic device within an electric power system, comprising:
a plurality of ports for receiving and transmitting data streams from intelligent electronic devices,
a router in communication with each of said ports for receiving said data streams and routing such to said intelligent electronic devices, and
a plurality of status indicators in communication with said router for displaying how the data streams are routed.

44. The data stream management device of claim 43, further comprising an input element in communication with said router, whereupon a signal from said input element routes a data stream in response thereto.

45. The data stream management device of claim 44, wherein said input element is a contact input.

46. The data stream management device of claim 44, wherein said input element is a command to a serial port.

47. The data stream management device of claim 43, wherein the status indicators comprise a plurality of LED's.

48. The data stream management device of claim 43, wherein the status indicators are LCD displays.

49. The data stream management device of claim 43, wherein the status indicators include data stream flow indicators.

50. The data stream management device of claim 43, wherein the status indicators include data stream direction indicators.

51. The data stream management device of claim 43, further comprising testing mechanism operable to test the operational status of the indicators.

52. The data stream management device of claim 43, wherein the ports are fiber optic connections.

53. The data stream management device of claim 43, further including an output element adapted for signaling an alarm condition.

54. The data stream management device of claim 43, further including an input element adapted for enabling the input for receiving the data stream from a first intelligent electronic device.

55. The data stream management device of claim 43, further including an output element adapted for signaling when a problem is detected with one of the ports.
